(19) United States
(12) Patent Application Publication
(10) Pub. No.: US 2023/0256405 A1
(43) Pub. Date: Aug. 17, 2023

(54) Channel Manifold

(71) Applicant: Fuel Tech, Inc., Warrenville, IL (US)

(72) Inventors: Ronald A. Lau, Palm Beach Gardens, FL (US); Karen Ringel, Eleva, WI (US)

(73) Assignee: Fuel Tech, Inc., Warrenville, IL (US)

(21) Appl. No.: 18/105,807

(22) Filed: Feb. 4, 2023

Related U.S. Application Data
(60) Provisional application No. 63/309,040, filed on Feb. 11, 2022.

(51) Int. Cl. B01F 35/71; B33Y 80/00

(52) U.S. Cl. CPC B01F 35/7182; B33Y 80/00; B01F 2101/305

(57) ABSTRACT

A channel manifold is presented, and which includes a dimensionally stable channel plate having top, bottom and side surfaces and a channel formed in a surface thereof, wherein the channel splits into a plurality of subsidiary channels along the surface of the channel plate and has an entrance port and a plurality of exit ports such that a fluid fed into the entrance port is expelled through the plurality of exit ports.

### TECHNICAL FIELD

The present disclosure relates to an injector or manifold, referred to herein as a channel manifold (“CM”) which facilitates injection of a first fluid into a second fluid, where the fluid can each be a gas or a liquid. In some embodiments, the CM can be used in a wastewater treatment process to deliver a treatment fluid to a body of water to be treated.

### BACKGROUND

Clean water is vital to our health, communities, economy, and the environment. The effective treatment of water often requires the dissolution of gases like air, oxygen, carbon dioxide, and ozone into drinking, agricultural, lake or wastewater. Wastewater treatment is becoming increasingly important due to diminishing water resources, increasing wastewater disposal costs, and stricter discharge regulations that have lowered permissible contaminant levels in waste streams. The diversity of water pollutants calls for a wide range of treatment methods that are not only effective, but also technologically and economically feasible.

In the effective treatment of water using the dissolution of gases like air, oxygen, carbon dioxide, and ozone, the air, oxygen, carbon dioxide, and/or ozone can be provided via aerated water or other fluid as a gas-laden liquid. In providing flow of gas-laden liquid (such as oxygenated water) within a host liquid such as a body of wastewater, it is sometimes desirable to provide for flow of the gas-laden liquid to be with a minimum of bubbles, in which case a flow rate which allows for a flow that has a Reynold's number of at least 4000, and includes minimal cavitation or nucleation sites for formation of bubbles.

In other embodiments, a gas-laden liquid is used in water treatment to aid in the production of bubbles to affect a physical separation of suspended solids from contaminated water, in which case the production of bubbles is sought. In yet other embodiments, gas-laden liquid is used as a carrier to provide a dissolved gas for chemical or biological treatment ends, such as for odor management or the breakdown of contaminants by oxygen-consuming bacteria.

Besides wastewater treatment, other applications exist for efficiently and effectively mixing a first fluid such as a gas like air, oxygen, carbon dioxide, and ozone into a second, including in industrial chemical reactions, producing biologics, beverages, foodstuffs, etc.

### BRIEF SUMMARY

In an embodiment, the present disclosure provides a channel manifold formed of a channel plate having at least one channel formed therein. The channel plate can be formed of a rigid material such as a rigid plastic like high density polyethylene, fiberglass, a resin, or a metal such as stainless steel, or the like. In some embodiments the channel takes the form of single channel fed by an entry port; in other embodiments, the channel splits and branches out into a plurality of branches to enable the channel manifold to inject, e.g., a fluid into a liquid container from a plurality of exit ports.

In some embodiments the channel plate is covered by a cover plate to cover the channel. The cover plate can, in some embodiments, include a channel formed therein, such as one to match that of the channel plate; in other embodiments the cover plate has a flat surface where it meets the channel plate to thusly close the channel of the channel plate. In embodiments where the cover plate has a flat surface where it meets the channel plate, the thusly-formed channel generally assumes an elongated “D” shape, that is, a flat surface formed by the cover plate and a channel in the channel plate, the channel having relatively flat walls and bottom and having rounded corners.

As such, in one aspect, the present disclosure provides a channel manifold having a dimensionally stable channel plate having top, bottom and side surfaces and a channel formed in a surface thereof, where the channel splits into a plurality of subsidiary channels along the surface of the channel plate and has an entrance port and a plurality of exit ports such that a fluid fed into the entrance port is expelled through the plurality of exit ports. In one embodiment, the channel splits into from 4 to 16 subsidiary channels.

In certain embodiments, the entrance port is in one surface of the channel plate and at least one of the exit ports is located in a different surface of the channel plate. In embodiments, the channel plate has a plurality of side surfaces and the entrance port is located in one side surface of the channel plate and at least one of the exit ports is located in a different side surface of the channel plate. In another embodiment, the entrance port is located in a top or bottom surface of the channel plate and at least one of the exit ports is located in a side surface of the channel plate.

The channel plate can be formed of a rigid material selected from the group consisting of a plastic, a resin, and a metal or alloy in some embodiments, and the channel can be formed by a process such as hot melting, laser etching, chemical etching, drilling, machining, stamping, injection molding, photolithography, or combinations thereof. In other embodiments, the channel is formed by forming the channel plate by 3D printing, with the channel formed therein during the 3D printing process.

The channel manifold also has a cover plate overlaid on the channel plate in certain embodiments, such that cover plate encloses and covers the channel formed in the channel plate. In embodiments, the cover plate is dimensionally stable and formed of a rigid material selected from the group consisting of a plastic, a resin, and a metal or alloy.

In certain embodiments, the total cross-sectional area of the channel is between about 4.5 mm² and about 13 mm², or even between about 6.5 mm² and about 11 mm². In embodiments, the operating pressure of the channel manifold is at least about 700 kPa; in some embodiments the operating pressure is at least about 1000 kPa, or, in some embodiments, about 1700 kPa to about 2700 kPa.

### BRIEF DESCRIPTION OF THE DRAWINGS

The disclosure will be better understood and its advantages more apparent when the following detailed description is read in conjunction with the accompanying drawings, in which:

FIG. 1 is a top plan view of an embodiment of the channel manifold of the present disclosure.

FIGS. 2a-2d are cross-sectional views of the channel manifold of FIG. 1 taken alone lines A-A, B-B, C-C, and D-D, respectively.

FIG. 3 is a side perspective view of the channel manifold of FIG. 1.

FIG. 4a is an end view of the channel manifold of FIG. 1, taken at its proximal end.

FIG. 4b is an end view of the channel manifold of FIG. 1, taken at its distal end.

FIG. 5 is a side perspective view of the channel manifold of FIG. 1 having a cover plate thereon.

FIGS. 6a-6d are cross-sectional views of the channel manifold of FIG. 5 taken along lines A-A, B-B, C-C, and D-D, respectively.

FIG. 7a is an end view of the channel manifold of FIG. 5, taken at its proximal end.

FIG. 7b is an end view of the channel manifold of FIG. 5, taken at its distal end.

FIG. 8 is a top plan view of another embodiment of the channel manifold of the present disclosure.

FIG. 9 is a side perspective view of the channel manifold of FIG. 8 having a cover plate thereon.

FIGS. 10a-10d are cross-sectional views of the channel manifold of FIG. 8 taken alone lines A-A, B-B, C-C, and D-D, respectively.

FIG. 11a is an end view of the channel manifold of FIG. 9, taken at its proximal end.

FIG. 11b is an end view of the channel manifold of FIG. 9, taken at its distal end.

FIG. 12 is a top plan view of still another embodiment of the channel manifold of the present disclosure.

FIG. 13 is a side perspective view of the channel manifold of FIG. 12 having a cover plate thereon.

FIG. 14 is a side perspective view of yet another embodiment of the channel manifold of the present disclosure.

FIGS. 15a-15d are cross-sectional views of the channel manifold of FIG. 14 taken alone lines A-A, B-B, C-C, and D-D, respectively.

FIG. 16 is a partially broken-away side plan view of a container having the channel manifold of FIG. 1 of the present disclosure positioned at the container wall to inject fluid thereinto.

FIG. 17 is a partially broken-away side plan view of a container having the channel manifold of FIG. 1 of the present disclosure positioned at the container bottom to inject fluid thereinto.

FIG. 18 is a partially broken-away side plan view of a container having the channel manifold of FIG. 14 of the present disclosure positioned at the container wall to inject fluid thereinto.

### DETAILED DESCRIPTION

Reference now will be made in detail to the embodiments of the present disclosure. It will be apparent to those skilled in the art that various modifications and variations can be made to the teachings of the present disclosure without departing from the scope of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

As used herein, the term “about” should be construed to refer to both of the numbers specified as the endpoint(s) of any range. Any reference to a range should be considered as providing support for any subset within that range.

For the sake of clarity, not all reference numerals are necessarily present in each drawing. In addition, positional terms such as “proximal”, “distal”, “upper,” “lower”, “side”, “top”, “bottom”, “vertical”, “horizontal”, etc. refer to the channel manifold of this disclosure when in the orientation shown in the drawings. The skilled artisan will recognize that the injectors can assume different orientations when in use.

“Reynolds number” or “Re” refers to the ratio of inertial forces to viscous forces within a fluid which is subjected to relative internal movement due to different fluid velocities, and is calculated by:

$$R e = \frac{uL}{ν} = \frac{ρ uL}{μ}$$

where:
ρ is the density of the fluid (SI units: kg/m³)
u is the flow speed (m/s)
L is a characteristic linear dimension (m) (see the below sections of this
article for examples)
μ is the dynamic viscosity of the fluid (Pa·s or N·s/m² or kg/(m·s))
v is the kinematic viscosity of the fluid (m²/s).

Referring now to the drawings, what is presented is a channel manifold 10, which comprises a channel plate 20. Channel plate 20 can be formed of any dimensionally stable material, such as a rigid material; in embodiments channel plate 20 is formed of a plastic such as high density polyethylene, a resin, fiberglass, or a metallic material or alloy such as stainless steel or brass. In some embodiments, channel plate 20 has a top and bottom surface 24a and 24b, respectively, and at least one side surface; indeed, in the embodiments where channel plate 20 is rectangular, it has 4 side surfaces 26a, 26b, 26c, and 26d, respectively (two along each side of its length and one at either end).

While the dimensions of channel plate 20 can vary widely by intended application, as would be known to the skilled artisan, in some embodiments channel plate 20 is rectangular and can have a length of from about 15 cm to about 30 cm; in other embodiments, channel plate 20 has a length of about 18 cm to about 26 cm. Furthermore, in certain embodiments channel plate 20 has a width of about 2 cm to about 8 cm; in yet other embodiments the width of channel plate 20 is about 2.5 cm to about 6 cm. The thickness (or height) of channel plate 20 can be, in some embodiments, from about 0.35 cm to about 1.1 cm; in other embodiments the thickness of channel plate 20 is about 0.5 cm to about 0.9 cm.

As noted, a channel 22 is formed in channel plate 20. Channel 22 can be formed by any conventional means. For instance, in some embodiments, channel 22 is formed by etching a channel into channel plate 20. In embodiments, etching can by mechanical means, such as by a drill; by a laser; or by chemical etching. In other embodiments, channel 22 is formed by hot melting, laser etching, machining, stamping, injection molding, photolithography, or by other means which would be known to the artisan. Alternatively, in some embodiments channel 22 is formed into channel plate 20 by producing channel plate 20 by 3D printing and forming channel 22 in channel plate 20 during the printing process.

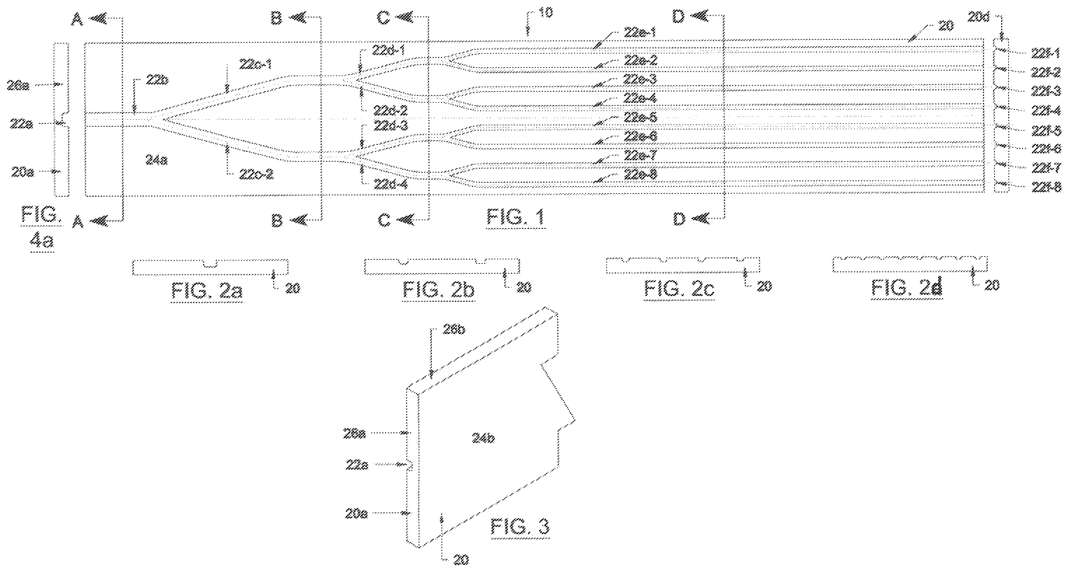

The cross-sectional shape of channel 22 can be any shape desired by the skilled worker in the art. For instance, the cross-sectional shape can, in some embodiments, be a semi-circle; in other embodiments the cross-sectional shape can be rectangular. In certain embodiments, however, the cross-sectional shape of channel 22 has generally flat sides and bottom and rounded corners, so as to assume an elongated “D” shape, as shown in cross-section FIGS. 2a-2d.

In embodiments, channel manifold 10 also comprises a cover plate 30, as shown in FIG. 5. Cover plate 30 serves to cover and close channel 22; as such, in some embodiments, cover plate has a generally flat surface, at least in those areas which overlay channel 22. In other embodiments, cover plate 30 has a channel formed therein (not shown) corresponding to channel 22. Cover plate 30 has dimensions the same or similar to those of channel plate 20 in some embodiments. In embodiments, cover plate 30 is bonded or adhered to channel plate 20 by suitable means, such as adhesives, glues, resins, etc. In other embodiments, cover plate 30 is bonded to channel plate 20 by use of nuts/bolts, screws, rivets, etc. If desired to ensure a leak-proof seal between cover plate 30 and channel plate 30, a gasket (not shown) may be interposed between the two.

Cover plate 30 can be formed of any dimensionally stable material, such as a rigid material; in some embodiments cover plate 30 is formed of a plastic such as high density polyethylene, a resin, fiberglass, or a metallic material or alloy such as stainless steel or brass. In certain embodiments, cover plate 30 is formed of the same material as channel plate 20.

Channel 22 can assume any path and size desired by the skilled worker, subject to the dimensions and dimensional stability of channel plate 20. While the cross-sectional dimensions of channel 22 can be selected by the artisan based on end use application, in some embodiments the total cross-sectional area of channel 22 taken along the length of channel 22 can be between about 4.5 mm² to about 13 mm²; in other embodiments the total cross-sectional area of channel 22 is about 6.5 mm² to about 11 mm².

In certain embodiments, channel 22 continues from a proximal end 20a of channel plate 20 to a distal end 20b of channel plate 20. For purposes of this disclosure, proximal end 20a can be considered the injection end of channel 22 and distal end 20b can be considered the ejection end of channel 22. In some embodiments, channel 22 splits (also often referred to as “diverges” or “bifurcates”) as it travels from proximal end 20a to distal end 20b of channel plate 20, an embodiment of which is shown for example in FIG. 1.

As shown in FIG. 1, in one embodiment of channel manifold 10 of the present disclosure, channel 22 has an entrance port 22a at proximal end 20a of channel plate 20 to allow a material intended to be passed along channel 22 access thereto from a source such as tube 200. From its entrance port 22a, channel 22 continues as a single channel 22b until it splits into two subsidiary channels 22c-1 and 22c-2. In the embodiment of FIG. 1, channel 22c-1 splits into further subsidiary channels 22d-1 and 22d-2 and channel 22c-2 splits into subsidiary channels 22d-3 and 22d-4, as shown. These channels then split into subsidiary channels 22e-1 through 22e-8, respectively, as shown in FIG. 1, which run parallel until exit ports 22f-1 through 22f-8 at distal end 20b. The cross-sections of FIGS. 2a-2d show the channels of the configuration of FIG. 1 after each split.

The cross-sectional area of each of channels 22b, 22c-1 and 22c-2, 22d-1 through 22d-4, and 22e-1 through 22e-8 (shown in FIGS. 2a-2d) can be selected by the artisan as desired and in accordance with the proposed end use of channel manifold 10. For instance, in some embodiments of the configuration of FIG. 1, channel 22b has a cross-sectional area of about 2.5 mm² to about 5 mm²; channels 22c-1 and 22c-2 each have a cross-sectional area of about 1.6 mm² to about 3 mm²; channels 22d-1 through 22d-4 each have a cross-sectional area of about 1.1 mm² to about 2.4 mm²; and channels 22e-1 through 22e-8 each have a cross-sectional area of about 0.6 mm² to about 1.8 mm².

While in the embodiment of FIG. 1, channel 22 splits into channels 22a-e which exit distal end 20b of channel plate 20, other embodiments are also possible. Indeed, the skilled artisan will recognize that other arrangements of channels are also feasible, depending on the intended end use of channel manifold 10. For instance, as illustrated in FIGS. 8 and 12, other arrangements where channel 22 splits into subsidiary channels 22e-1 through 22e8-4, but not each of the channels exits at distal end 20b, again subject to the needs of the end use application of channel manifold 10.

Depending on the end use application of channel manifold 10 and the arrangement and dimensions of channel 22, in certain embodiments the operating pressure of channel manifold 10, that is the pressure of the fluid moving through channel 22, is at least about 700 kPa. In other embodiments the operating pressure is at least about 1000 kPa; in certain embodiments the operating pressure is from about 1700 kPa to about 2700 kPa. In yet other embodiments, the operating pressure of channel manifold 10 is about 1800 kPa to about 2400 kPa. The flow rate of fluid along channel 22 can be, in certain embodiments, at least about 4.5 liters per minute (lpm); in some embodiments the flow rate is from about 5.3 lpm to about 11 lpm. In still other embodiments the flow rate is from about 6 lpm to about 10 lpm. These flow velocities can also function to help sweep away any small bubbles that may form during depressurization.

In some embodiments, channel manifold 10 is design such that the mass through each subsidiary channel is balanced, is to insure the same flow velocity through each subsidiary channel. Indeed, As the pressure drop rate (pressure drop per inch) is important, the channel design is such that the bulk velocity is constant in every channel. So, the flow area in channel 22b can be taken as V1 through an area A1. When it splits into channels 22c-1 and 22c-2, the same velocity is maintained by having the area of the channels 22c-1 and 22c-2 each be A2=0.50×A1, and so on. Indeed, the total flow area (=A1) is maintained so that for N subsidiary channels, the area of each subsidiary channel is =A1/N.

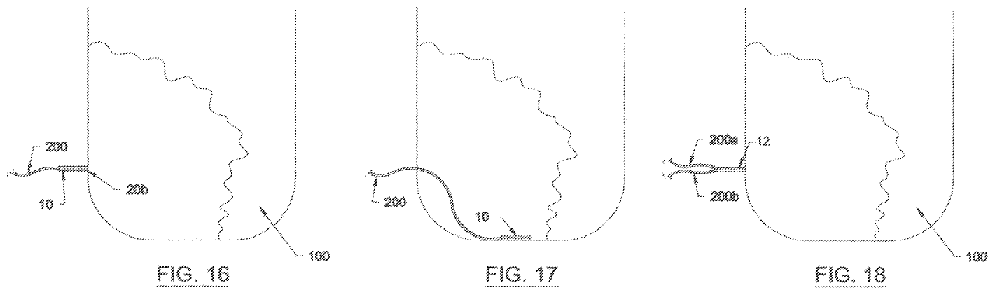

In certain embodiments, such as shown in FIG. 16, channel manifold 10 of FIG. 1 (or other channel manifold 10 having its channel 22 end at distal end 20b) is positioned with respect to a container 100 such that distal end 20b extends into the interior of container 100 so fluid provided through tube 200 is ejected through channels 22e-1 through 22e-8 and mixes with fluid in container 100. In other embodiments, channel manifold 10 can be positioned within container 100, as shown in FIG. 17.

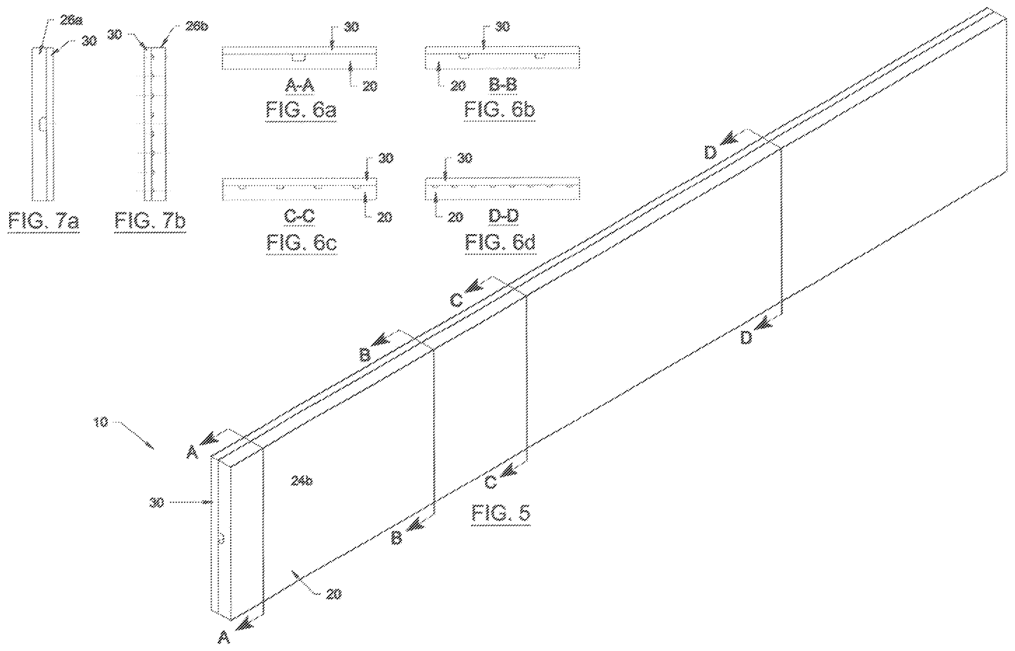

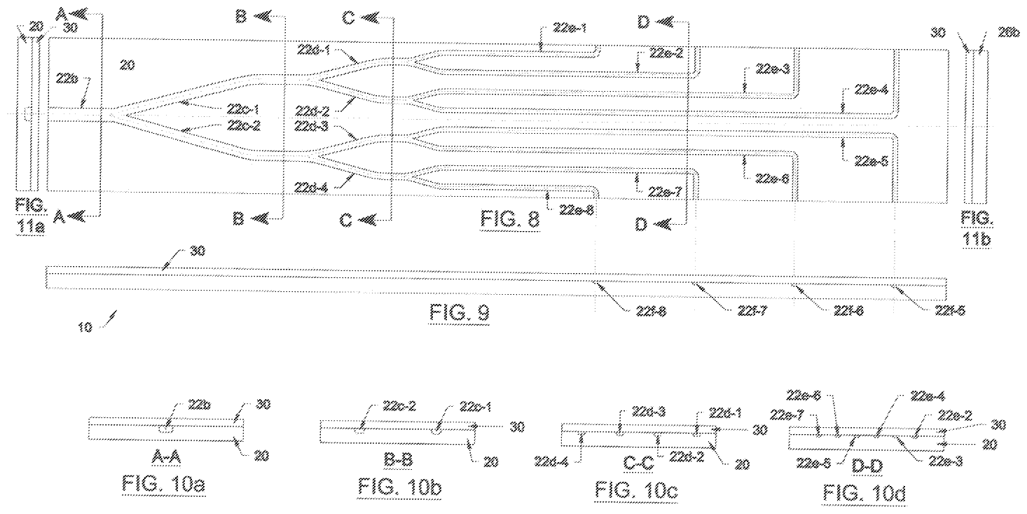

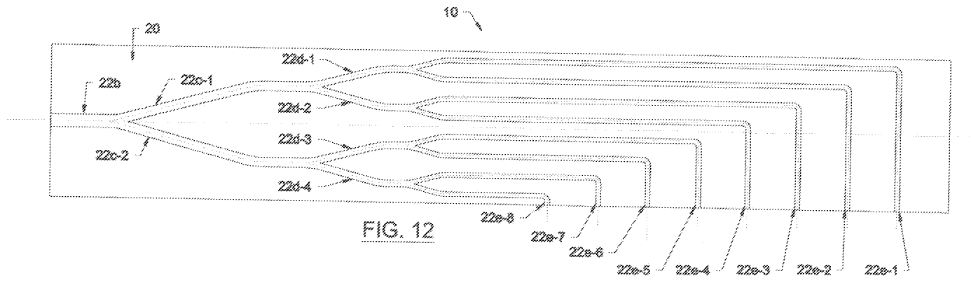

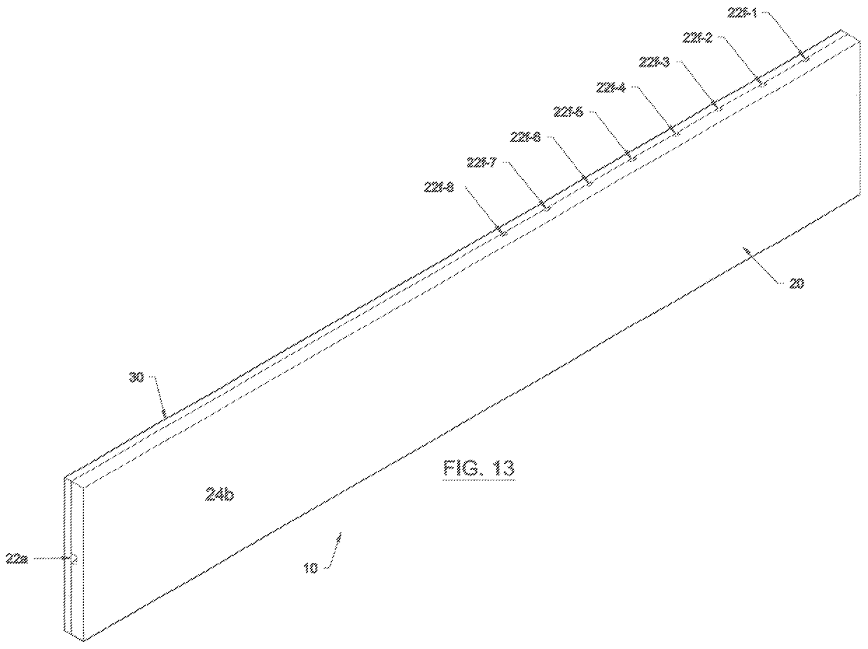

In operation in accordance with the embodiments shown in FIGS. 1-17, fluid is passed into channel 22 of channel manifold 10 through entrance port 22a by, e.g., tube 200 and is forced through the respective subsidiary channels to exit channel manifold 10 through exit ports 22f-1 through 22f-8.

In some embodiments, applications for channel manifold 10 of this disclosure include as a feed stream for processes that introduce into water a depressurized feed stream in a manner that minimizes bubble size (and, thus, produce more bubbles) for making material chemically or biologically available. In certain embodiments, a majority of the bubbles produced are less than 10 microns in average diameter. In other embodiments, channel manifold 10 of this disclosure provides a feed stream for processes that depressurize the feed stream to maximize bubbles of predetermined sizes for use in dissolved air flotation wherein the gas is used to physically separate or treat a receiving body of contaminant-laden liquid. Other applications needing an efficient, pressurized gas-laden liquid stream provided by channel manifold 10 of this disclosure exist or may be contemplated.

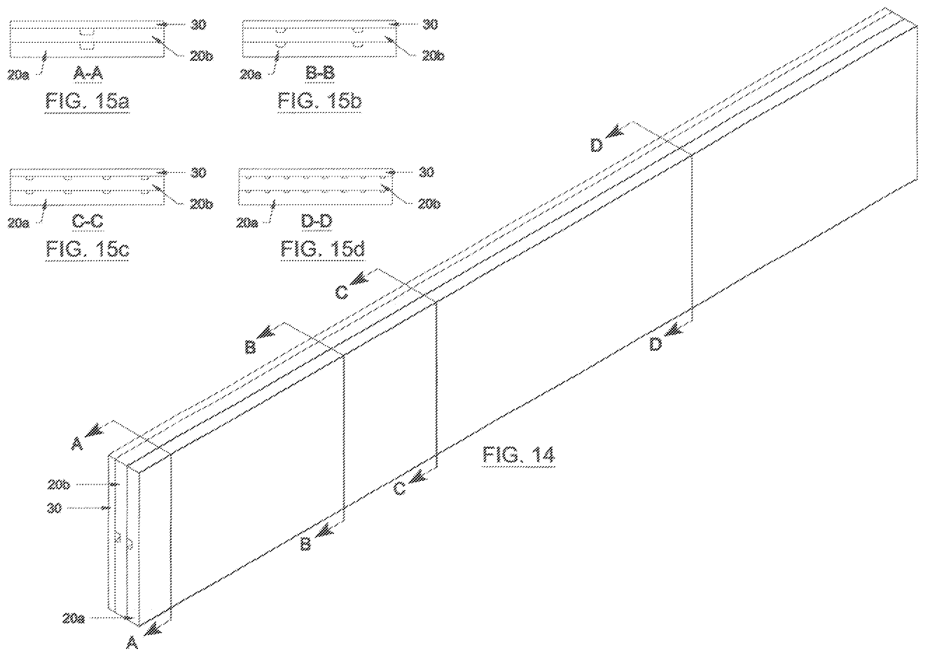

In yet another embodiment, a channel manifold 12 is provided in a “stacked” arrangement, as illustrated in FIGS. 14 and 15a through 15d, where multiple (in this case two) channel plates 20a and 20b are stacked, such that the bottom of channel plate 20b acts as a cover for the channels of channel plate 20a, with a cover plate 30 over the channels of channel plate 20b. In this way, higher total throughput can be achieved by increasing the number of channels in channel manifold 10. In use, stacked manifold 12 can be positioned with respect to a container 100 such that the egress ports of manifold 12 extend into the interior of container 100, as shown in FIG. 18, such that fluid fed through tubes 200a and 200b is fed through manifold 12 and mixes with fluid in container 100.

All references cited in this specification, including without limitation, all patents, patent applications, and publications, and the like, are hereby incorporated by reference into this specification in their entireties. The discussion of the references herein is intended merely to summarize the assertions made by their authors and no admission is made that any reference constitutes prior art. Applicant reserves the right to challenge the accuracy and pertinence of the cited references.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. Therefore, the spirit and scope of the appended claims should not be limited to the description of the versions contained therein.

What is claimed is:

1. A channel manifold comprising a dimensionally stable channel plate having top, bottom and side surfaces and a channel formed in a surface thereof, wherein the channel splits into a plurality of subsidiary channels along the surface of the channel plate and has an entrance port and a plurality of exit ports such that a fluid fed into the entrance port is expelled through the plurality of exit ports.

2. The channel manifold of claim 1, wherein the channel splits into from 4 to 16 subsidiary channels.

3. The channel manifold of claim 1, wherein the entrance port is in one surface of the channel plate and at least one of the exit ports is located in a different surface of the channel plate.

4. The channel manifold of claim 3, wherein the channel plate has a plurality of side surfaces and the entrance port is located in one side surface of the channel plate and at least one of the exit ports is located in a different side surface of the channel plate.

5. The channel manifold of claim 3, wherein the entrance port is located in a top or bottom surface of the channel plate and at least one of the exit ports is located in a side surface of the channel plate.

6. The channel manifold of claim 1, wherein the channel plate is formed of a rigid material selected from the group consisting of a plastic, a resin, and a metal or alloy.

7. The channel manifold of claim 6, wherein the channel is formed by hot melting, laser etching, chemical etching, drilling, machining, stamping, injection molding, photolithography, or combinations thereof.

8. The channel manifold of claim 6, wherein the channel is formed by forming the channel plate by 3D printing, with the channel formed therein.

9. The channel manifold of claim 1, further comprising a cover plate overlaid on the channel plate, such that cover plate encloses and covers the channel formed in the channel plate.

10. The channel manifold of claim 9, wherein the cover plate is dimensionally stable and formed of a rigid material selected from the group consisting of a plastic, a resin, and a metal or alloy.

11. The channel manifold of claim 9, wherein the total cross-sectional area of the channel is between about 4.5 mm² and about 13 mm².

12. The channel manifold of claim 11, wherein the total cross-sectional area of the channel is between about 6.5 mm² and about 11 mm².

13. The channel manifold of claim 11, wherein the operating pressure is at least about 1000 kPa.

14. The channel manifold of claim 11, wherein the operating pressure is about 1700 kPa to about 2700 kPa.
